(19) United States
(12) Patent Application Publication
(10) Pub. No.: US 2026/0036799 A1
(43) Pub. Date: Feb. 5, 2026

(54) CONFOCAL MICROSCOPY SYSTEM WITH FREE-SPACE OPTICS LINKAGE

(71) Applicant: Lumencor, Inc., Beaverton, OR (US)

(72) Inventors: Steven M. JAFFE, Portland, OR (US); Alex JASSO, Portland, OR (US); Claudia B. Jaffe, Portland, OR (US)

(21) Appl. No.: 19/205,369

(22) Filed: May 12, 2025

Related U.S. Application Data
(63) Continuation of application No. PCT/US23/37220, filed on Nov. 13, 2023.
(60) Provisional application No. 63/424,904, filed on Nov. 12, 2022.

(51) Int. Cl. G02B 21/00; G02B 21/36

(52) U.S. Cl. CPC G02B 21/0076; G02B 21/0032; G02B 21/0044; G02B 21/361

(57) ABSTRACT

A spinning disk confocal microscopy system, and components thereof, with improved illumination. The system may include (1) a light engine, (2) confocal optics, such as Yokogawa spinning disk confocal optics, (3) a detector, and (4) a free-space optics linkage. The light engine may include at least one light source configured to produce fluorescence excitation light. The confocal optics may direct the fluorescence excitation light from the light engine onto a fluorescent sample and collect fluorescence emission light emitted by the sample. The detector may capture fluorescence emission light from the sample to form an image of the sample. The free-space optics linkage may direct fluorescence excitation light from the light engine to the confocal optics, at least in part through free space.

CROSS-REFERENCES

This application is a continuation of PCT Patent Application Serial No PCT/US2023/037220, filed Nov. 13, 2023, which, in turn, is based upon and claims the benefit under 35 U.S.C. § 119(e) of U.S. Provisional Patent Application Ser. No. 63/424,904, filed Nov. 12, 2022. These applications are incorporated herein by reference in their entireties for all purposes.

### INTRODUCTION

Light microscopy comprises a spectrum of approaches that use visible (or near visible) electromagnetic radiation to produce an image of an object. Typically, the specimen is tiny (e.g., a cell), and the goal is to generate a high-magnification (500-1000×) image with excellent resolution and contrast. The different approaches are distinguished by their methods of generating contrast and/or their resolution.

Fluorescence microscopy is the dominant form of light microscopy in the biological sciences. It is sensitive, selective, and compatible with multi-color imaging of living specimens. In this approach, fluorescent specimens emit radiation (“fluoresce”), primarily in the visible, and that emitted radiation is captured to create an image. Fluorescent specimens emit (“emission”) in response to energy input (“excitation”), which (except in the case of multi-photon excitation) is supplied by higher-energy, shorter-wavelength radiation. Because the input light is spectrally distinct, it can be blocked using filters. The result is a high-contrast image showing a fluorescence signal against a dark background. Most biological samples are not intrinsically fluorescent, and thus samples must be labeled with fluorescent tags (fluorophores). The tags typically are designed to interact with specific constituents of interest (e.g., in cells), so signals arise only from well-defined species or structures.

There are two standard forms of fluorescence microscopy. The most basic form, termed “widefield” microscopy, generally illuminates all positions and all depths of the sample simultaneously. Unfortunately, this can lead to blurring, especially with thick samples, because the image will include contributions from above and below the image plane. An alternative form, termed “confocal” microscopy, generates images with markedly reduced blur by scanning the sample with a focused illumination spot and then rejecting out-of-focus fluorescence using a pinhole filter located in a conjugate image plane (disposed between the sample and the detector). Laser scanning confocal microscopy (LSCM) uses a single illumination spot and a single pinhole. It is very effective at reducing blur. However, it is also very slow, making it poorly suited for imaging of live samples. Spinning disk confocal microscopy (SDCM) overcomes the speed limitation, allowing imaging of live samples, by simultaneously using many spots and many pinholes. However, spreading the excitation light over many spots means that the excitation light can be less intense, reducing fluorescence and slowing imaging. Moreover, suitable light sources can be expensive, and their alignment with downstream components finicky. In addition, imaging capability may be lost if the illumination fails to excite fluorescence from enough of the sample to fill, without necessarily overfilling, the detector. Thus, there is a need for confocal microscopy systems, particularly spinning disk confocal microscopy systems, with enhanced illumination capabilities.

### SUMMARY

The present disclosure provides a spinning disk confocal microscopy system, and components thereof, with improved illumination. The system may include (1) a light engine, (2) confocal optics, such as Yokogawa spinning disk confocal optics, (3) a detector, and (4) a free-space optics linkage. The light engine may include at least one light source configured to produce fluorescence excitation light. The confocal optics may direct the fluorescence excitation light from the light engine onto a fluorescent sample and collect fluorescence emission light emitted by the sample. The detector may capture fluorescence emission light from the sample to form an image of the sample. The free-space optics linkage may direct fluorescence excitation light from the light engine to the confocal optics, at least in part through free space.

### BRIEF DESCRIPTION OF THE DRAWINGS

FIG. 1 is a very high-level schematic view of a confocal microscopy system, in accordance with aspects of the present disclosure. The system may include a light engine, confocal optics, detector, and free-space optics linkage.

FIG. 2 is a more detailed schematic view of aspects of a confocal microscopy system, such as the system of FIG. 1, emphasizing the light engine.

FIG. 3 is a more detailed schematic view of aspects of a confocal microscopy system, such as the system of FIG. 1, emphasizing the free-space optics linkage in relation to an upstream light engine and downstream confocal optics.

FIG. 4 is a cross-sectional view of a first exemplary free-space optics linkage having a folded light path, showing how the linkage directs light from a suitable light engine (at left) to suitable confocal optics (at right).

FIG. 5 is a slightly exploded isometric view of the free-space optics linkage of FIG. 4, rotated approximately 180 degrees about a vertical axis relative to FIG. 4, such that excitation light enters the linkage at the upper right and exits the linkage at the lower left.

FIG. 6 is an exploded isometric view of light-engine-side components of the free-space optics linkage of FIG. 4.

FIG. 7 is an exploded isometric view of confocal-optics-side components of the free-space optics linkage of FIG. 4.

FIGS. 8A,B are elevated isometric views of the free-space optics linkage of FIG. 4, showing the linkage installed between a light engine and confocal optics. Panel (A) shows the light engine at left and confocal optics at right. Panel (B) shows the system rotated approximately 180 degrees about the vertical, with the light engine at right and the confocal optics at left. In both cases, excitation light is generated by the light engine and travels from the light engine through the linkage to the confocal optics.

FIGS. 9 and 10 are isometric views of a second exemplary free-space optics linkage having a folded light path, again showing how the linkage directs light from a suitable light engine (at left) to suitable confocal optics (at right).

FIGS. 11 and 12 are cross-sectional views of the free-space optics linkage of FIGS. 9 and 10, taken generally along lines 11-11 and 12-12 in FIGS. 9 and 10, respectively.

FIG. 13 is an isometric view of the translation mechanism of the free-space optics linkage of FIGS. 9-12.

FIG. 14 is an isometric view of the free-space optics linkage of FIGS. 9-13, showing the linkage in relation to a mount for the light engine and a pair of exemplary collimating lenses (i.e., the downstream lenses for the beam expander).

FIG. 15 is a more detailed partially schematic view of aspects of a confocal microscopy system, such as the system of FIG. 1, emphasizing the confocal optics and detector. The objective and sample may be a portion of and supported by a microscope, respectively.

### DETAILED DESCRIPTION

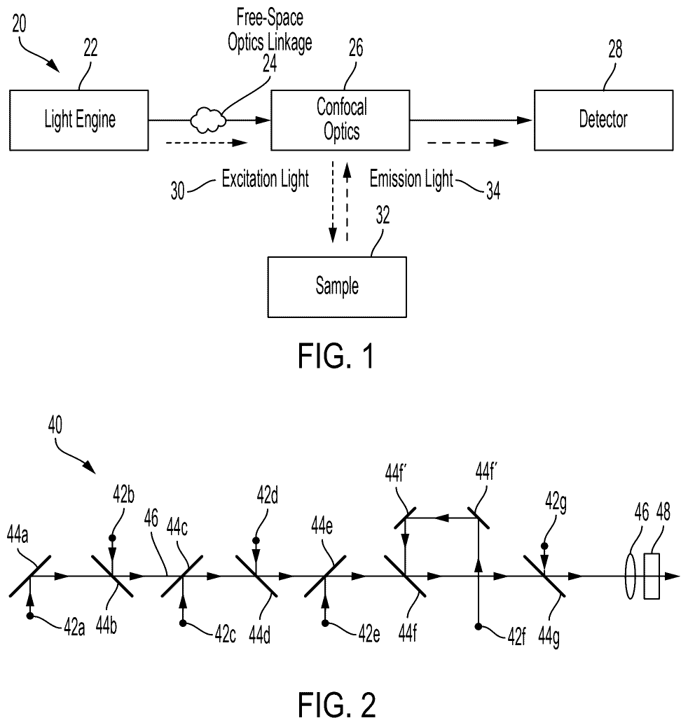

FIG. 1 shows an exemplary confocal microscopy system 20 with a free-space optics linkage, in accordance with aspects of the present disclosure. The system may include a light engine 22, a free-space optics linkage 24, confocal optics 26, and a detector 28. The light engine may include at least one light source, such as a single-or multi-mode laser, configured to produce fluorescence excitation light 30. The free-space optics linkage may direct fluorescence excitation light from the light engine to the confocal optics through free space, without requiring a fiber optic or liquid light guide. The confocal optics, which may include a pinhole disk and optional lens disk, among others, may be configured to direct the fluorescence excitation light received from the free-space optics linkage onto a sample 32 and to collect fluorescence emission light 34 emitted by the sample. In spinning disk embodiments, the confocal optics may simultaneously illuminate and collect light from at least two discrete positions (“spots”) in the sample separated by an unilluminated region, enhancing the rate of data collection. Finally, the detector may be configured to capture fluorescence emission light from the sample to form an image of the sample. Significantly, the free-space optics linkage may provide certain advantages over other light conveyance mechanisms. For example, it may provide greater light output and/or greater uniformity, which, in turn, may improve image quality. It also may avoid light losses and modal noise associated with fiber optics or light guides that arise due to bends in the optics, among other factors. It also may simplify and thus speed up initial alignment. It also may be more stable and thus help maintain existing alignment. Further aspects of the system, and its components, are described below.

### I. Light Engine

The light engine is used to generate fluorescence excitation light capable of exciting fluorescence from the sample. It may include one or more individual light sources (e.g., one, two, three, four, five, six, seven, eight, nine, or more sources). The light sources may include lasers, light pipes, and/or light-emitting diodes (LEDs), among others. The lasers may include single-and/or multi-mode lasers. Each light source may be capable of emitting at one or more predominantly single wavelengths (e.g., 488 nm or 514 nm) or over one or more ranges of wavelengths (e.g., 450 nm to 550 nm). In some cases, two or more light sources may output light having the same spectral qualities, where the light from the two or more sources is combined to increase its intensity. In other cases, two or more light sources may output light having different spectral qualities, expanding the range of available excitation wavelengths such that the light engine can be used with a broader range and number of fluorophores. The intensity of light from each light source may be independently adjustable, for example, from 0% to 100% relative intensity. Light output by the light engine may come from a single source or be a blend of light from two or more sources. The spectral properties of light output by the light engine may be matched to its intended use, for example, to excite fluorescence from preselected fluorescent tags. The light engine may optionally include a diffuser and/or despeckler for reducing laser speckle and/or other inhomogeneities. The light engine may include reflective elements, such as mirrors, and/or refractive elements, such as lenses, for combining light from different light sources onto a single optical pathway. Exemplary light engines may include, among others, the Lumencor ZIVA Light Engine. See Appendices A1 and A2 in U.S. Provisional Patent Application Ser. No. 63/424,904, filed Nov. 12, 2022, for details.

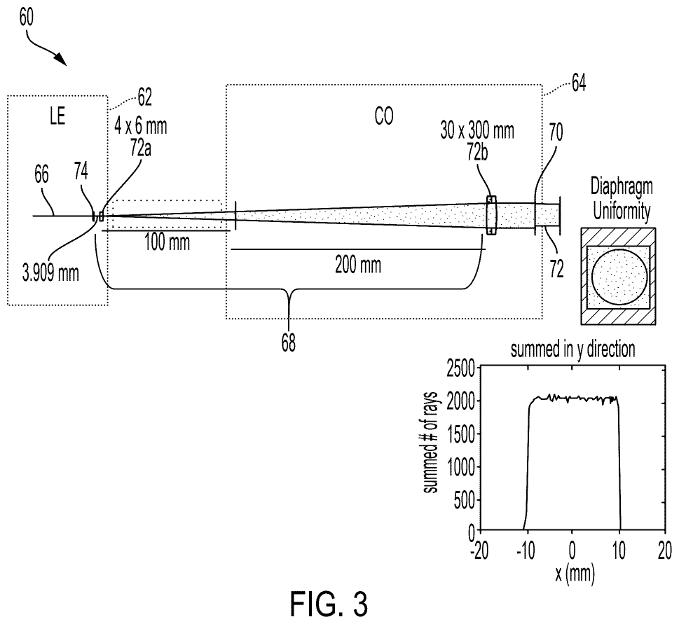

FIG. 2 shows a more detailed schematic view of an exemplary light engine 40. This light engine includes seven light sources 42a-g and seven associated mirrors 44a,g. Other light engines, as noted above, may include fewer light sources or more light sources. Light from the light sources is combined and directed toward a free-space optics linkage along a single optical path 46. An initial (farthest upstream) light source 42a may be positioned directly in the optical path. Alternatively, as shown here, the initial light source may be positioned off the optical path. In this case, light from the initial light source is reflected along the optical path by an appropriately oriented initial mirror 44a. This mirror may be fully silvered (i.e., 100% reflective) to reduce light loss. Alternatively, it may be a dichroic mirror that only reflects wavelengths of interest. Subsequent light sources 42b-g may be positioned off the optical path (to avoid blocking light). Light from these downstream light sources may be directed into the optical path using downstream mirrors 44b-g. These mirrors may be partially silvered, dichroic, or multi-dichroic so that light from upstream sources can pass through the mirrors while light to be added by the downstream light sources is reflected into the optical path. Partially silvered mirrors reflect and transmit light at least substantially uniformly across the spectrum (e.g., a 50:50 partially silvered mirror reflects half of incident light and transmits half, etc.). In contrast, the extent to which dichroic and multi-dichroic mirrors reflect and transmit light depends on wavelength. A dichroic mirror may be constructed to transmit most or substantially all upstream light, so it continues along the optical path, and to reflect most or substantially all input light, so it is redirected along the optical path. In some cases, light from two or more light sources may be combined before being directed along the optical path. In the same or other cases, light may follow a more convoluted path before being directed into the optical path. For example, light from a downstream light source 42f may bounce off one or more auxiliary mirrors 44f′ before reflecting off a primary mirror 44f into the optical path. The light engine may include additional optics 46, such as reflective and/or refractive optics, spectral (e.g., low-pass, bandpass, and high-pass) filters to modify the spectrum ((relative) wavelength content) of the light, neutral density filters to modify the overall intensity of the light, and/or polarizers to modify the polarization of the light, among others. These additional optics may be positioned and used in connection with individual light sources and/or positioned and used in the common optical path. The light engine also may include elements such as a despeckler 48 and/or homogenizer to despeckle and/or otherwise homogenize light produced by the light engine. The optical pathway in FIG. 2 is operatively “linear,” in that light from each additional light source is added to the light from all preceding light sources. However, in other embodiments, the optical pathway may be “branched,” in that light from two or more light sources may be added before being added to light from other light sources. Relatedly, the optical pathway in FIG. 3 is operatively two-dimensional, in that the light sources and optical paths are shown as coplanar. However, in other embodiments, one or more light sources may be in different planes from one another and/or the optical path, and/or the optical path may be shifted out of plane before exiting the light engine.

The light sources in this exemplary embodiment may include one or more lasers (including being exclusively lasers). The lasers may be single-mode lasers, multi-mode lasers, or mixtures thereof. Multi-mode lasers may have advantages over single-mode lasers, such as lower cost and/or higher output power (brightness or intensity). Typically, only one light source is used at a time to provide excitation light tailored to a specific fluorophore. However, in some applications, two or more light sources may be “on” at a given time.

### II. Free-Space Optics Linkage

The free-space optics linkage is used to direct excitation light from the light engine to the confocal optics and, in the process, to prepare the light for use by the optics. It most generally comprises any mechanism other than a fiber optic or light guide for coupling light from the light engine to the confocal optics. More specifically, it comprises mechanisms that include transmitting the light through free space. Suitable lenses, such as achromats, plan achromats, fluorite, apochromats, and/or plan apochromats, among others, may be used to prepare light for entry into the free-space optics linkage, to prepare light exiting the linkage for entry into the confocal optics, and/or to manipulate light within the linkage (e.g., to expand it). Similarly, suitable mirrors, such as planar mirrors, convex mirrors, and concave mirrors, among others, may be used to direct light into, within, and out of the free-space optics linkage. These lenses and mirrors, whose positions may be fixed or variable, may be parts of the linkage and/or be shared with or integrated into the light engine and/or confocal optics.

FIG. 3 shows a more detailed schematic view of aspects of a confocal microscopy system, such as the system of FIG. 1, emphasizing the free-space optics linkage 60 in relation to an upstream light engine 62 and downstream confocal optics 64. The linkage may include a homogenizer 66, a beam expander 68, and/or a baffle or diaphragm 70, among other components. The light path through the linkage may be linear, as shown, or folded. An advantage of a folded path may include facilitating alignment of the light engine and confocal optics (e.g., by allowing light to exit the light engine at one height and enter the confocal optics at another height, measured relative to one another or to a benchtop or other shared support structure). Another advantage may include a more compact shape, reducing the linkage's footprint. Here, upstream components of the free-space optics linkage, particularly the homogenizer, are shared with the light engine, and downstream components of the free-space optics linkage, particularly components of the beam expander, are shared with the confocal optics.

The homogenizer 66 may comprise any component for scrambling or otherwise rendering more uniform the light (particularly transverse to the direction of propagation). Examples may include a rigid rod such as a drawn glass (silica) or plastic rod, typically embedded in a support. The rod may have any suitable length and cross-section. Exemplary lengths may be about 10 to 100 millimeters, about 25 to 75 millimeters, about 40 to 60 millimeters, or about 50 millimeters, among others. Exemplary cross-sectional shapes may be at least substantially circular, rectangular, or square, among others. Exemplary cross-sectional dimensions may be between about 50 and 5000 microns, about 100 and 3000 microns, about 200 and 1000 microns, and about 300 to 500 microns, among others. For example, a homogenizer with a square profile may be about 400 by 400 microns, among others. In some embodiments, the homogenizer may be incorporated into the light engine. In other embodiments, it may be housed with other components of the free-space optics linkage. In the latter case, the homogenizer and any associated support or housing may be insertable into an exit port for the light engine and in the process may actuate any associated interlocks.

The beam expander 68 may comprise any mechanism for expanding the cross-sectional dimension(s) of the excitation light transverse to its direction of propagation. The beam expander may, in addition, collimate the excitation light (so that the envelope of excitation light is neither converging nor diverging significantly as it exits the free-space optics linkage). Examples include Galilean beam expanders and Keplerian beam expanders, among others. The beam expander may be telecentric. The excitation light beam may be expanded using appropriate combinations of refractive (and, in some cases, reflective) elements. For example, two lenses 72a,b may be used. The first (upstream) lens 72a, such as a 4×6 mm lens, among others, may be positioned sufficiently close (e.g., within its focal length, such as about 3.909 mm) to the output 74 of the homogenizer that light passing through the lens diverges. The second (downstream) lens 72b, such as a 30×300 mm lens, among others, may be positioned such that light 76 exiting the second lens is collimated and parallel. This may be accomplished by positioning the second lens at a distance at least approximately equal to its focal length (e.g., about 300 mm) from the first lens. The two lenses more generally comprise a typically smaller typically stronger upstream lens, operatively closer to the light engine, and a typically larger typically weaker downstream lens, operatively closer to the confocal optics. In some embodiments, the magnification, or relative increase in beam size, achieved by the beam expander may be at least substantially equal to the ratio of the focal lengths of the downstream and upstream lenses (e.g., in the above example, about a 300/6=50-fold expansion). The expanded beam can be used to illuminate simultaneously multiple lenslets, if present, and pinholes in a spinning disk confocal optics system. The expanded beam also may be sized to properly fill the system's camera sensor, reducing waste illumination that would otherwise not be captured by the sensor. Toward this end, the system may include a selectable plurality of second (collimating) lenses, such as 200, 250, and 300 mm focal-length second lenses, where the user can select the second lens that best matches the camera sensor. Typically, smaller focal length lenses are used for smaller camera sensors, and larger focal length lenses are used for larger camera sensors. The expanded beam may have a profile matching that of the homogenizer. For example, a square or circular homogenizer may produce a square or circular expanded beam, among others.

The baffle or diaphragm 70 may comprise any mechanism for limiting or sculpting the transverse profile of the excitation light beam. It may be positioned at any suitable position(s) in the light path, for example, downstream from the second lens in the beam expander. The baffle may limit the amount of extraneous or unneeded excitation light entering the confocal optics, reducing scattering and associated signal background, among other advantages. The baffle, like the homogenizer, may have any suitable cross-sectional shape and size. For example, its shape may be matched to the shape of the homogenizer and thus the expanded beam. For example, a square baffle may be matched with a square homogenizer, among other possibilities. Moreover, the dimensions of the baffle may be fixed (such as a static aperture) or variable (such as an adjustable iris diaphragm).

FIG. 3 further shows an exemplary transverse beam profile for the expanded beam. In general, the expanded beam may have any suitable or desired illumination profile (e.g., as described above, one whose outer contours are matched to those of the homogenizer and/or baffle). However, in most situations, the beam profile should be at least substantially uniform (i.e., have an at least substantially constant intensity transverse to the direction of beam propagation). This helps to ensure that variations in the image reflect variations in the sample and not (uninteresting) variations in the illumination.

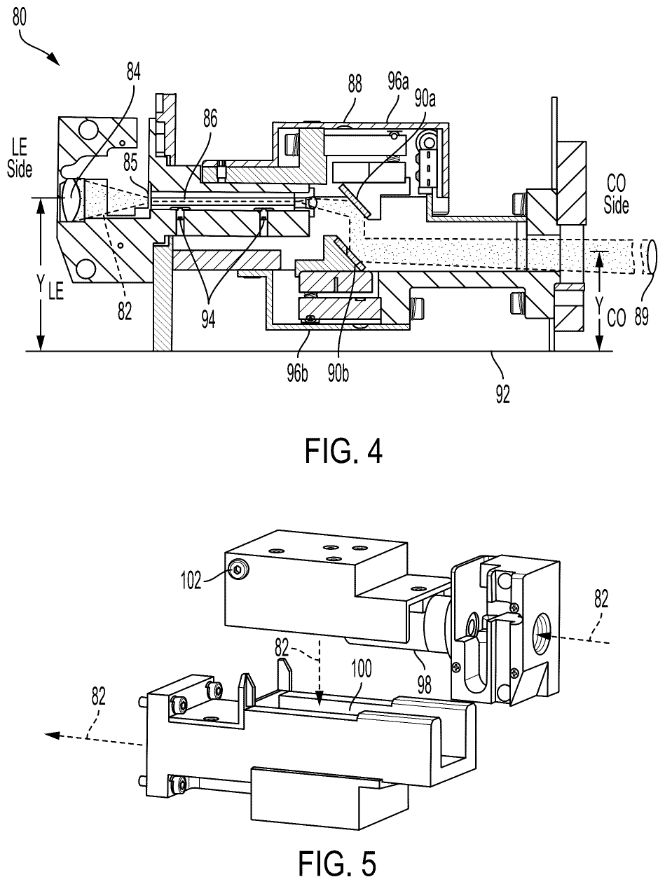

FIGS. 4-8 show details of a first exemplary free-space optics linkage 80 having a folded light path. FIG. 4 is a cross-sectional view of the linkage. The linkage includes light engine (LE) side components (shaded darker in FIG. 4) and confocal optics (CO) side components (shaded lighter in FIG. 4). These components may be joined together to form a variable-height folded light path between the light engine (left) and the confocal optics (right). Excitation light 82 from the light engine is focused by a lens 84 onto and into an upstream end 85 of a rod homogenizer 86. Light exiting a downstream end 87 of the homogenizer is then expanded by a beam expander, such as a two-lens telecentric beam expander. Here, as in the previous embodiment, the beam expander comprises a smaller-diameter, shorter-focal-length upstream lens 88 and a larger-diameter, longer-focal-length downstream lens 89. A pair of opposed mirrors 90a,b in the light path adjusts (raises or lowers) the height of the beam, even as it is expanding, so that light exiting the light engine at a height YLE relative to a shared support 92 (or other suitable reference height) is directed into the confocal optics at a height Y_{CO} relative to the shared support (or other suitable reference height). Exemplary supports may include a breadboard or tabletop associated with a vibration isolation table or benchtop, among others. Lowering and/or raising the beam while simultaneously expanding the beam (i.e., performing these functions in parallel) may offer significant advantages over performing the functions serially. In particular, it may reduce the pathlength of the beam through the linkage and the overall footprint of the linkage. The upstream (LE side) and downstream (CO side) mirror assemblies 90a,b used to lower and raise the beam may be the same (as shown) or different. The heights and orientations of the homogenizer rod and mirrors may be adjustable using suitable adjustment mechanisms, such as homogenizer set screws 94 and 96a,b, respectively, to fine tune both the height and direction of the beam. In some embodiments, one or more of these components may be fixed. For example, one mirror may be adjustable, and one mirror may be fixed.

FIG. 5 shows aspects of the free-space optics linkage 80 of FIG. 4, rotated approximately 180 degrees about a vertical axis relative to FIG. 4, such that excitation light 82 enters the linkage at the upper right and exits the linkage at the lower left. The linkage may include complementary boss and channel portions to facilitate and maintain assembly. More specifically, a protruding boss portion 98 may be received in and supported at least in part by a recessed channel portion 100. Here, the boss portion is associated with light entering the linkage from the light engine, and the channel portion is associated with light exiting the linkage to the confocal optics. The linkage may include one or more interlocks 102.

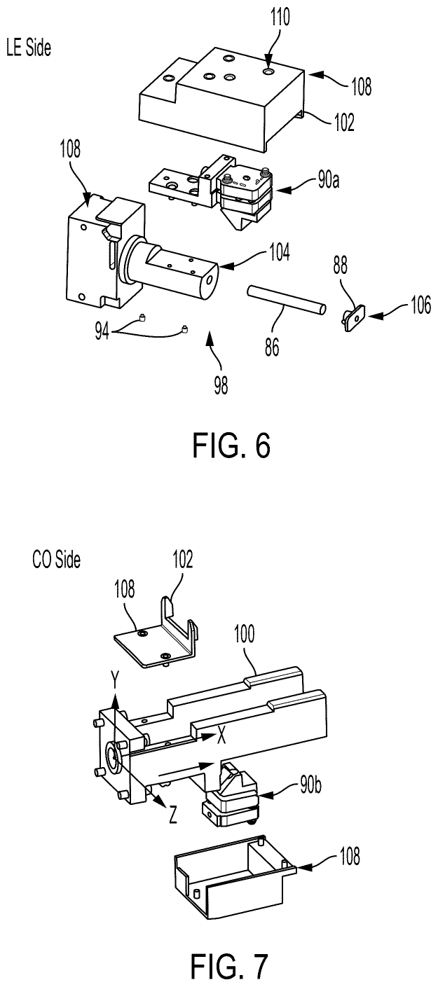

FIGS. 6 and 7 show aspects of the light-engine (LE) side (FIG. 6) and confocal-optics (CO) side (FIG. 7) of the free-space optics linkage 80 of FIG. 4. Light generally travels left to right and up to down through FIG. 6. Components unique to the light-engine side include, among others, boss portion 98, homogenizer rod 86, an extended snout 106 to hold the homogenizer rod, homogenizer set screws 94 used to set the orientation and position of the homogenizer rod, upstream beam expander lens 88, and a lens holder 108 for the upstream beam expander lens. Light generally travels right to left and down from up through FIG. 7. Components unique to the confocal-optics side include, among others, channel portion 100. The channel portion may be used to set the position and angle orientation of the light engine. The light engine may be allowed to float in Z (i.e., vertically) with respect to the confocal optics. The length of the channel may further set the distance between the light engine and confocal optics. Both the light-engine side and confocal-optics side of the linkage include mirrors 90a,b, such as right-angle mirrors, to raise, lower, and/or otherwise steer the light beam. Both the light-engine side and confocal-optics side of the linkage also may include one or more covers 108. The covers may be formed using any suitable method and materials (e.g., 3D printing, machining, and/or sheet metal) and may function to keep out extraneous light (and/or keep in excitation light) and/or to protect both the linkage and operators. The linkage and covers further may include one or more interlock switches (interlocks) 102, for example, to turn off the light source(s) if an associated cover is removed. In some embodiments, the covers may include holes and/or other apertures 110, for example, to allow access to set screws, among other options.

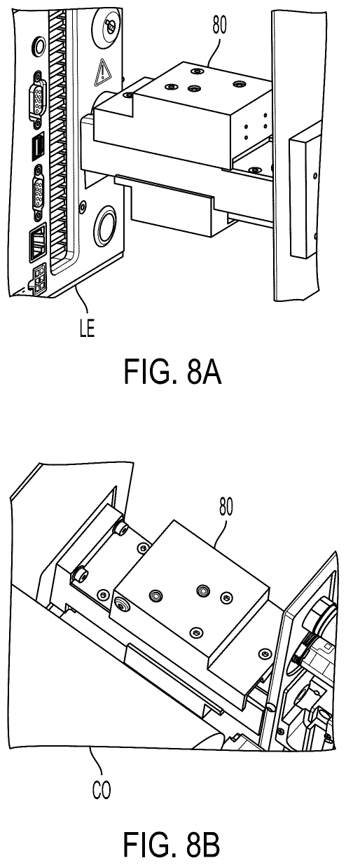

FIG. 8 shows the assembled free-space optics linkage 80 of FIGS. 4-7 in relationship to the light engine (LE) and confocal optics (CO). Panel (A) shows the connection between the linkage and light engine. Various switches, ports, status lights, and the like are visible on the light engine. Panel (B) shows the connection between the linkage and confocal optics.

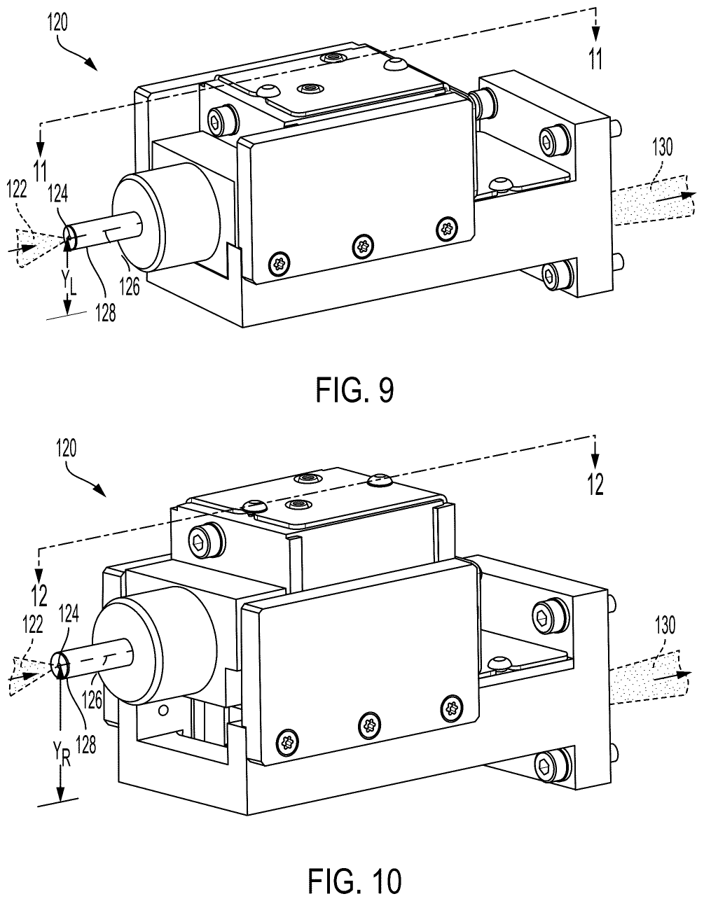

FIGS. 9-13 show aspects of a second exemplary free-space optics linkage 120 having a folder light path. This linkage is very similar to linkage 80 in FIGS. 4-8. In particular, the linkage includes substantially the same components in substantially the same arrangement. Therefore, to reduce redundancy, this description will emphasize selected differences between the linkages and/or features not already described in connection with previous linkages (even if they were present).

FIGS. 9 and 10 show linkage 120 assembled in two configurations: lowered (or unextended) (FIG. 9) and raised (or extended) (FIG. 10). The degree of extension corresponds to the vertical separation Y between the input light 122 traveling from the light engine (as measured at the entrance 124 to the homogenizer 126 (located inside a protective sleeve 128)) and the output light 130 traveling toward the second lens of the beam expander and the confocal optics. The respective separations may be referred to as Y_{L} in the fully lowered configuration, Y_{R} in the fully raised configuration, and Y for intermediate separations. (The variable Y similarly can be used to describe the difference Y_{LE}−Y_{CO} in FIGS. 4-8.) In this embodiment, the homogenizer is more closely associated with the linkage chassis than in the embodiment of FIGS. 4-8.

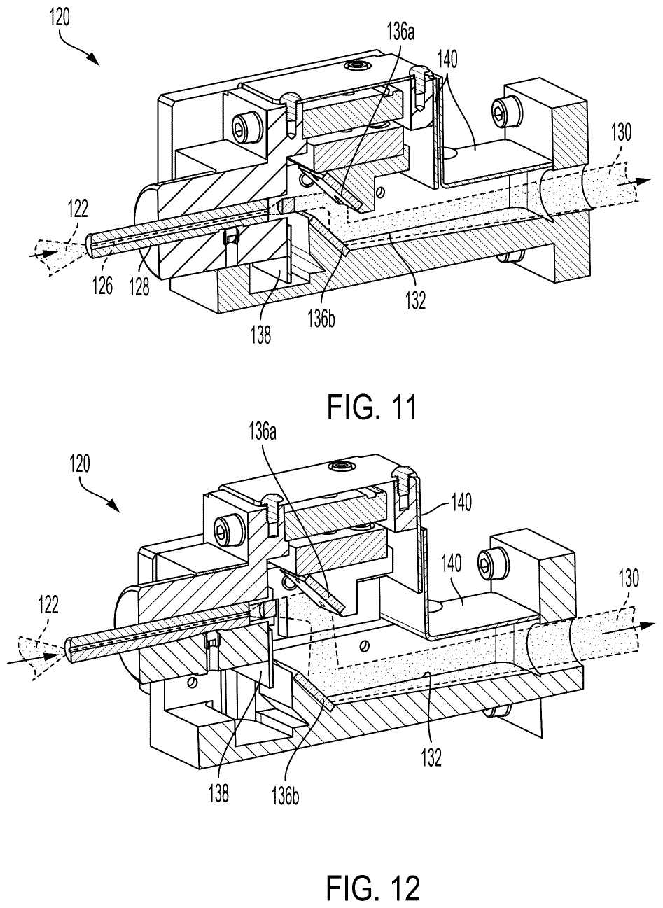

FIGS. 11 and 12 are cross-sectional views showing linkage 120 assembled in the same lowered and raised configurations as FIGS. 9 and 10, respectively. Here, it is easy to trace the path of light 132 through the system, from input light 122 at upper left to output light 130 at lower right. In particular, as in previous embodiments, the light passes through a homogenizer rod 126, which is enclosed in a protective sleeve 128, and a lens 134, which is the first lens of the beam expander, after which it is reflected off a pair of right-angle steering mirrors 136a,b to adjust its height. It is also easy to see in the cross-sectional views how the height difference between input and output light corresponds to a height difference between the two mirrors These mirrors may be adjustable or fixed. In this case, the upper mirror 136a is adjustable, and the lower mirror 136b is fixed. Fixing one mirror may simplify alignment (by reducing the number of variables that must be adjusted). Fixing the lower mirror means that the adjustable mirror is on top and thus easier to access. The system includes internal light baffles 138 and external light baffles 140 that keep light localized within the system and simultaneously prevent internal light from escaping, where it might create a safety hazard, and external light from entering, where it might contaminate the illumination. Light travels a shorter distance through the illustrated portions of the linkage in the lowered configuration than in the raised configuration. This, in turn, will affect the placement of the second lens of the beam expander, so that the path length between the first and second lens will generate collimated light after the second lens.

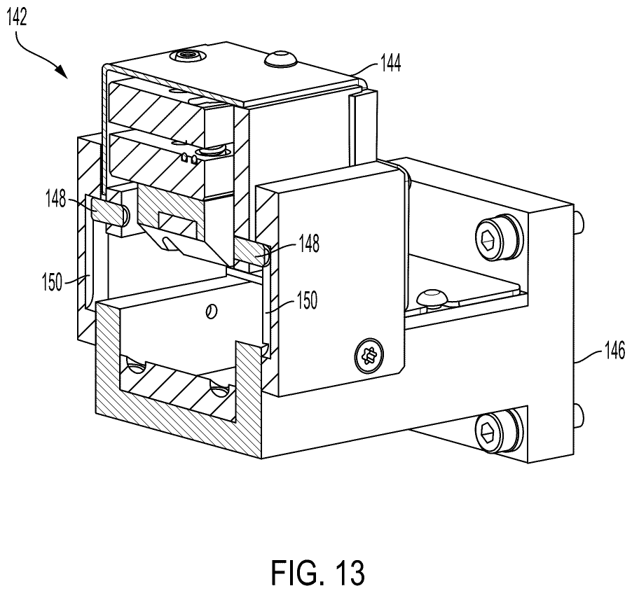

FIG. 13 shows portions of the free-space optics linkage associated with adjusting the separation between the mirrors (and, thus, adjusting the height difference between the input light coming from the light engine and the output light traveling toward the confocal optics. This translation mechanism 142 includes a movable upper half 144 that mates with the light engine and a fixed lower half 146 that mates with the confocal optics. The translation itself makes use of guide pins 148, here associated with the movable upper half, that are received by and travel in corresponding guide grooves 150, here associated with the fixed lower half. The pin-and-groove mechanism may at least substantially preserve the relative orientations of the mirrors as the height is adjusted (raised or lowered).

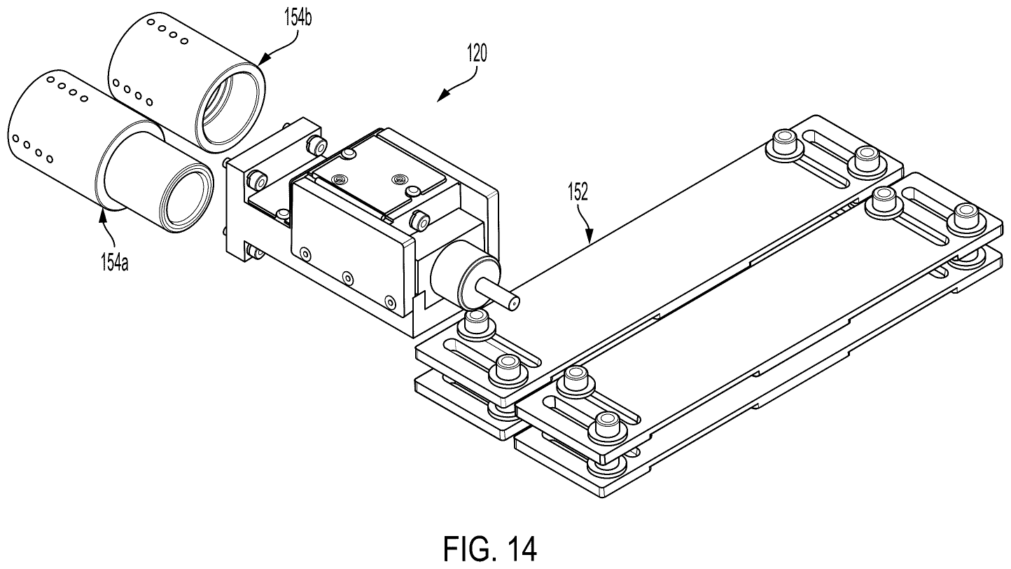

FIG. 14 shows the free-space optics linkage 120 of FIGS. 9-13 in relation to a mount 152 for the light engine and a pair of exemplary collimating lenses (i.e., downstream lenses for the beam expander) 154a,b having different focal lengths. The figure shows a 30×250 mm lens 154a and a 30×300 mm lens 154b. These lenses, as noted above, need to be positioned at a distance at least approximately equal to their focal lengths from the first lens in the beam expander to produce collimated expanded light. The associated lens holders 156a,b are configured accordingly. Higher focal length lenses are associated with higher magnifications or beam diameters, as discussed above. In some embodiments, there may be additional collimating lenses, such as 30×350 mm lenses, among others. Here, as elsewhere in the disclosure, the first number (30 mm) refers to the lens diameter, and the second number (250 mm, 300 mm, 350 mm) refers to the lens focal length. Generally, lenses may have any suitable diameters and focal lengths.

See Appendix B in U.S. Provisional Patent Application Ser. No. 63/424,904, filed Nov. 12, 2022, for alternative representations of the free-space optics linkage and its relationship to other components of the confocal microscopy system.

### III. Confocal Optics

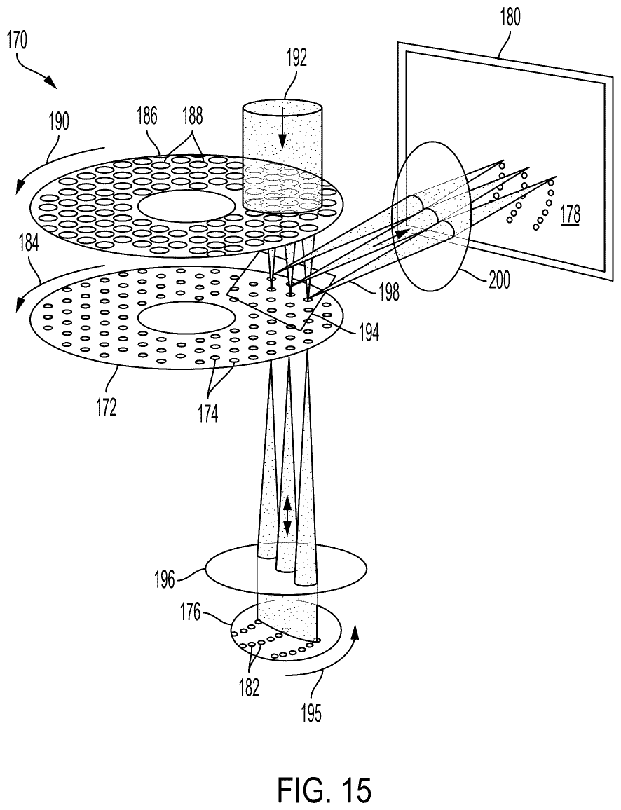

The confocal optics are used to achieve confocal illumination and detection from a sample. FIG. 15 shows a more detailed view of exemplary confocal optics 170. These optics may be arranged in any suitable configuration, including folded optics configurations. In particular, the optics may be integral to the microscope or housed in a unit coupled to but separate from the microscope. Spinning disk confocal optics include a pinhole disk 172, such as a Nipkow disk, containing tens, hundreds, thousands, or tens of thousands of (typically equal-sized) pinholes 174. The disk and its pinholes are located in a conjugate image plane. In other words, the pinhole disk, the sample 176, and the image 178 ultimately formed on the detector 180 are simultaneously in focus. Typically, a subset (e.g., ˜1000) of the pinholes is illuminated, and an objective projects their minified images 182 onto a sample to achieve multi-beam illumination. The pinhole disk is spun, as indicated by the arrow 184, causing the illuminated spots to move across the sample such the entire sample is eventually illuminated. In some embodiments, the entire sample can be illuminated with just a partial rotation of the disk, and this can be accomplished in as little as a millisecond. In other embodiments, the disk may rotate through one or more revolutions to take an image, and/or the process may take longer, including much longer, than a millisecond.

The pictured embodiment, which can be termed a Yokogawa system, further includes an optional lens disk 186, matched to the pinhole disk, which contains a set of Fresnel or other microlenses 188 that focus the excitation light onto aligned pinholes in the pinhole disk. The lens disk is spun, as indicated by arrow 190, in tandem with the pinhole disk, maintaining their relative alignments. The use of microlenses in the excitation path enhances light relative to systems that lack microlens arrays. The result may be markedly improved image brightness, especially with less intense light sources. Rapid image acquisition may be achieved using pinholes arranged in sets of nested spirals that illuminate the specimen uniformly and generate a complete image after only a partial (e.g., each 30°) rotation of the disk.

In use, excitation light 192 generated by a light engine, and conveyed to the confocal optics by the free-space optics linkage, is projected onto a portion of the lens disk. The excitation light is focused by the illuminated lenses in the lens disk onto corresponding pinholes in the pinhole disk, passing in the process through a dichromatic (or multi-dichromatic) beamsplitter 194. Excitation light from the pinholes is focused onto discrete spots that spin across the sample, as indicated by arrow 195, by an intervening objective lens 196. The spots typically spin in phase with the spinning of the pinhole disk and, if present, the lens disk. Fluorophores in the illuminated spots create fluorescence emission light 198. A portion of the emission generated by each spot passes back through the same pinhole as the excitation light that induced the emission, leading to preferential rejection of out-of-focus fluorescence signal. Specifically, out-of-focus emission is blocked because it is defocused and so (mostly) misses the pinhole (and adjacent pinholes). Unlike the excitation, the emission bypasses the microlens array (when present) and is directed toward and projected onto the detector (typically, an imaging detector) by the dichromatic (or multi-dichromatic) beamsplitter disposed between the pinhole and lens disks. The beamsplitter passes excitation light, as mentioned above, while reflecting the spectrally distinct emission light. A tube lens 200 and/or other optics disposed between the beamsplitter and detector may help focus the emission light onto the detector. In some embodiments, excitation and emission filters may be operatively positioned between the light source(s) and the beamsplitter in the excitation optical path and between the beamsplitter and the detector in the emission optical path, respectively. The excitation filter(s) may be positioned in the light engine, in the free space optics, and/or in the confocal optics (e.g., adjacent to and upstream from the beamsplitter), among others, The emission filter(s) may be positioned in the confocal optics (e.g., adjacent to and downstream from the beamsplitter) and/or in the detector, among others. Excitation filters generally “clean up” the excitation light, passing only wavelengths or wavelength regimes suitable for exciting fluorophores of interest. Emission filters similarly generally clean up the emission light, most importantly by blocking errant excitation light that might otherwise be mistaken for emission.

The spinning disk system can, in principle, capture up to several thousand frames per second, which is markedly superior to an LSCM. In reality, other limitations typically lead to reduced acquisition rates. One example is the need to collect an acceptably strong signal from a dim sample, which often places an upper bound of 10 frames/second on acquisition rates. Thus, the use of a high-quality free-space optics linkage, such as that described here, may be very important for speeding up image acquisition.

Exemplary confocal optics may include, among others, the Yokogawa CSU-W1® and CSU-X1® confocal scanner units. These may be used with any suitable microscope or microscope platform. Exemplary microscopes may include, among others, the Nikon Eclipse Ti2® inverted research microscope. See Appendices C1 and C2 in U.S. Provisional Patent Application Ser. No. 63/424,904, filed Nov. 12, 2022, with respect to confocal optics and Appendix D in the same application with respect to microscopes and microscope platforms.

### IV. Detector

The detector is used to capture fluorescence emission light generated by the confocal optics and generate an image. Laser-scanning confocal microscopy typically employs a point detector because the image is built up one point at a time. Examples include a photomultiplier tube (PMT) and a photodiode, among others. Spinning disk confocal microscopy typically employs an imaging detector. Examples include a charge-coupled device (CCD), an electron-multiplying charge coupled device (EMCCD), a complementary metal-oxide-semiconductor (CMOS) device, and a high quantum efficiency back-illuminated scientific complementary metal-oxide semiconductor (sCMOS) device, among others. Exemplary detectors may include, among others, the pco.edge 3.1@ scientific CMOS camera. See Appendix E in U.S. Provisional Patent Application Ser. No. 63/424,904, filed Nov. 12, 2022, for more details.

### V. Selected Aspects

This section describes additional selected aspects of the present disclosure, presented without limitation as a series of paragraphs, some or all of which may be numerically indexed for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.
1. A spinning disk confocal microscopy (SDCM) system, comprising (a) a light engine including at least one light source, the light engine being configured to produce fluorescence excitation light; (b) confocal optics configured to direct the fluorescence excitation light onto a sample and to collect fluorescence emission light emitted by the sample, wherein the confocal optics simultaneously illuminate and collect light from at least two discrete positions in the sample separated by an unilluminated region; (c) a detector configured to capture fluorescence emission light from the sample to form an image of the sample; and (d) a free-space optics linkage that transmits fluorescence excitation light output from the light engine to the confocal optics.
2. The system of paragraph 1, wherein the free-space optics linkage does not include a fiber optic or light guide.
3. The system of paragraph 2, wherein free-space optics includes a light homogenizer.
4. The system of paragraph 3, wherein the light homogenizer has a square cross-section.
5. The system of paragraph 4, wherein the cross-section is about 400 microns by 400 microns.
6. The system of any preceding paragraph, wherein the free-space optics include a beam expander.
7. The system of paragraph 6, the beam expander having first and second lenses, wherein the first lens has a smaller diameter and a shorter focal length than a diameter and a focal length of the second lens, and wherein the first lens is positioned upstream of the second lens.
8. The system of paragraph 7, wherein the first and second lenses are converging lenses.
9. The system of paragraph 7 or 8, the free-space optics linkage having a homogenizer, wherein an optical path length between an output of the homogenizer and the first lens is equal to or less than a focal length of the first lens.
10. The system of any of paragraphs 7 to 9, wherein an optical path length between the first and second lenses is at least about equal to a focal length of the second lens.
11. The system of any of paragraphs 6 to 10, wherein excitation light is collimated after passing through the beam expander.
12. The system of any of paragraphs 7 to 11, the second lens being a first collimating lens having a first focal length, further comprising a second collimating lens having a second focal length, the first and second focal lengths being unequal, wherein only one of the first and second collimating lenses is used in the beam expander at a given time.
13. The system of paragraph 12, wherein the first focal length is greater than the second focal length, and wherein the first collimating lens creates an expanded beam having a larger transverse beam profile than the second collimating lens.
14. The system of paragraph 13, the detector being an imaging detector, wherein the detector has an imaging area, and wherein which of the first and second collimating lenses is used in the beam expander depends on which lens maximally fills without overfilling the imaging area.
15. The system of any of paragraphs 12 to 14, further comprising a third collimating lens having a third focal length, wherein none of the first, second, and third focal lengths are equal.
16. The system of any of paragraphs 6 to 15, wherein at least a portion of the light output by the beam expander has an at least substantially uniform intensity profile transverse to a direction of propagation of the beam.
17. The system of any preceding paragraph, wherein the free-space optics linkage includes a mechanism for adjusting a height of the output excitation light relative to the input excitation light.
18. The system of paragraph 17, wherein the mechanism includes a pair of opposed mirrors.
19. The system of paragraph 18, wherein the position and/or orientation of at least one of the mirrors is adjustable.
20. The system of paragraph 19, wherein both mirrors are adjustable.
21. The system of any of paragraphs 17 to 20, wherein the mechanism for adjusting the height includes at least one guide pin in a movable part of the linkage that travels in a corresponding guide groove in a fixed part of the linkage.
22. The system of any preceding paragraph, wherein the light engine includes at least two lasers.
23. The system of paragraph 22, wherein each laser emits light at a different wavelength or range of wavelengths.
24. The system of any preceding paragraph, the light engine including at least three separate light sources, wherein two of the light sources produce light having the same spectral qualities, and wherein such light is combined to increase its intensity.
25. The system of any preceding paragraph, wherein the light engine emits light in at least two distinct wavelength regimes.
26. The system of paragraph 25, wherein the intensity of light in each of the at least two distinct wavelength regimes is independently adjustable.
27. The system of paragraph 25, wherein the intensity of light in one wavelength regime can be held constant while the intensity of light in the other wavelength regime is varied.
28. The system of any preceding paragraph, wherein the light from each light source is reflected by a mirror before being combined with light from another light source.
29, The system of paragraph 28, wherein the orientation of the mirror can be adjusted to align the light produced by the source with light produced by other sources.
30. The system of paragraph 28, wherein the orientation of the mirror can be adjusted to align the light produced by the source with an entrance to the free-space optics linkage.
31. The system of any preceding paragraph, wherein light from each light source is directed along a same optical path.
32. The system of paragraph 31, wherein the light is directed onto the free-space optics linkage.
33. The system of any preceding paragraph, wherein the light sources are mounted on a common platform.
34. The system of paragraph 33, wherein the light sources are positioned within recesses in the platform.
35. The system of any preceding paragraph, wherein the confocal optics include a Nipkow pinhole disk.
36. The system of paragraph 35, wherein an intensity of excitation light incident on the pinhole disk is substantially uniform over at least a portion of the pinhole disk illuminated by the excitation light.
37. The system of paragraph 35 or 36, wherein the confocal optics further include a lens disk.
38. The system of any preceding paragraph, wherein the confocal optics are Yokogawa optics.
39. The system of any preceding paragraph, wherein the detector includes an imaging detector.
40. The system of paragraph 39, wherein the imaging detector is a charge-coupled device (CCD).
41. The system of paragraph 39, wherein the imaging detector is a complementary metal-oxide-semiconductor (CMOS) device.
42. The system of any preceding paragraph, further comprising a controller that controls the wavelength(s) and/or duration of light emitted by the light engine.
43. A spinning disk confocal microscopy (SDCM) system, comprising (a) a light engine including at least one light source, the light engine being configured to produce fluorescence excitation light; (b) confocal optics configured to direct the fluorescence excitation light onto a sample and to collect fluorescence emission light emitted by the sample, wherein the confocal optics simultaneously illuminate and collect light from at least two discrete positions in the sample separated by an unilluminated region; (c) a detector configured to capture fluorescence emission light from the sample to form an image of the sample; and (d) a pair of lenses and a pair of mirrors to expand and collimate the excitation light and lower or raise the excitation light, respectively, while directing the excitation light from the light engine to the confocal optics, wherein the excitation light is lowered or raised while it is simultaneously being expanded.
44. The system of paragraph 43, further comprising any compatible one or more limitations of paragraphs 1 to 42.
45. A method of performing confocal microscopy, comprising (a) providing or selecting the system of any of paragraphs 1-44; (b) providing or selecting a sample; and (c) using the system to form an image of the sample.
46. The method of paragraph 45, further comprising (a) providing or selecting the system of any of paragraphs 17 to 21; and (b) adjusting a height of the output excitation light relative to a height of the input excitation light, so that light can travel from the light engine through the linkage to the confocal optics.
47. The method of paragraph 45, further comprising (a) providing or selecting the system of any of paragraphs 12 to 15; and (b) selecting a second lens from the plurality of second lenses to fill without overfilling an imaging area of the detector.
48. The method of paragraph 47, further comprising (a) replacing the detector with a new detector; and (b) replacing the second lens with a new second lens having a different focal length to fill without overfilling an imaging area of the new detector.
49. The method of claim 45, the free-space optics linkage having a mechanism for adjusting a height of the output excitation light relative to the input excitation light, further comprising adjusting a height of the output excitation light relative to a height of the input excitation light, so that light can travel from the light engine through the linkage to the confocal optics.
50. The method of claim 45, the free-space optics linkage having a beam expander comprising an upstream lens and a pair of candidate downstream collimating lenses, wherein the upstream lens has a smaller diameter and a shorter focal length than a diameter and a focal length of either of the candidate downstream collimating lens, and wherein the focal lengths of the two candidate downstream collimating lenses are unequal, further comprising selecting the one of the two candidate downstream collimating lenses that most nearly fills without overfilling an imaging area of the detector to use in the beam expander.
51. The method of claim 50, further comprising (a) replacing the detector with a new detector; and (b) replacing the downstream collimating lens with a new downstream collimating lens having a different focal length to better fill without overfilling an imaging area of the new detector.

### VI. Conclusions

The term “and/or” as used in the present disclosure means all combinations of the listed elements. For example, a list with two elements “A and/or B” means A, B, or both. Similarly, a list with three elements “A, B, and/or C” means A, B, C, A and B, A and C, B and C, or all three. The extension to four or more elements follows the same pattern.

The term “exemplary” as used in the present disclosure means “illustrative” or “serving as an example” and is not intended to imply desirability or superiority.

The term “fluorescence” as used in the present disclosure means optical radiation emitted in response to absorption of light. Thus, fluorescence as used here covers any form of photoluminescence, including standard fluorescence and phosphorescence, in which the absorption of one or more photons promotes an electron to an excited state and leads to subsequent emission of a new photon, whether from a singlet state, a triplet state, or other state.

The headings used within the present disclosure are for organization purposes only.

The light paths and beam profiles shown in the drawings are for illustration purposes and may not be to scale. However, more precise paths and profiles may be determined by simple ray tracing or other techniques using information given in the disclosure, such as focal lengths and optical path lengths.

The disclosure set forth herein may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A spinning disk confocal microscopy (SDCM) system, comprising:
a light engine including at least one light source, the light engine being configured to produce fluorescence excitation light;
confocal optics configured to direct the fluorescence excitation light onto a sample and to collect fluorescence emission light emitted by the sample, wherein the confocal optics simultaneously illuminate and collect light from at least two discrete positions in the sample separated by an unilluminated region;
a detector configured to capture fluorescence emission light from the sample to form an image of the sample; and
a free-space optics linkage that transmits fluorescence excitation light output from the light engine to the confocal optics.

2. The system of claim 1, wherein the free-space optics linkage does not include a fiber optic or light guide.

3.-5. (canceled)

6. The system of claim 1, wherein the free-space optics include a beam expander.

7. The system of claim 6, the beam expander having first and second lenses, wherein the first lens has a smaller diameter and a shorter focal length than a diameter and a focal length of the second lens, and wherein the first lens is positioned upstream of the second lens.

8. (canceled)

9. The system of claim 7, the free-space optics linkage having a homogenizer, wherein an optical path length between an output of the homogenizer and the first lens is equal to or less than a focal length of the first lens.

10.-11. (canceled)

12. The system of claim 7, the second lens being a first collimating lens having a first focal length, further comprising a second collimating lens having a second focal length, the first and second focal lengths being unequal, wherein only one of the first and second collimating lenses is used in the beam expander at a given time.

13. The system of claim 12, wherein the first focal length is greater than the second focal length, and wherein the first collimating lens creates an expanded beam having a larger transverse beam profile than the second collimating lens.

14. The system of claim 13, the detector being an imaging detector, wherein the detector has an imaging area, and wherein which of the first and second collimating lenses is used in the beam expander depends on which lens maximally fills without overfilling the imaging area.

15. The system of claim 12, further comprising a third collimating lens having a third focal length, wherein none of the first, second, and third focal lengths are equal.

16. (canceled)

17. The system of claim 1, wherein the free-space optics linkage includes a mechanism for adjusting a height of the output excitation light relative to the input excitation light.

18.-20. (canceled)

21. The system of claim 17, wherein the mechanism for adjusting the height includes at least one guide pin in a movable part of the linkage that travels in a corresponding guide groove in a fixed part of the linkage.

22.-24. (canceled)

25. The system of claim 1, wherein the light engine emits light in at least two distinct wavelength regimes.

26. (canceled)

27. The system of claim 25, wherein the intensity of light in one wavelength regime can be held constant while the intensity of light in the other wavelength regime is varied.

28. The system of claim 1, wherein the light from each light source is reflected by a mirror before being combined with light from another light source.

29. The system of claim 28, wherein the orientation of the mirror can be adjusted to align the light produced by the source with light produced by other sources.

30. The system of claim 28, wherein the orientation of the mirror can be adjusted to align the light produced by the source with an entrance to the free-space optics linkage.

31.-34. (canceled)

35. The system of claim 1, wherein the confocal optics include a Nipkow pinhole disk.

36. The system of claim 35, wherein an intensity of excitation light incident on the pinhole disk is substantially uniform over at least a portion of the pinhole disk illuminated by the excitation light.

37. The system of claim 35, wherein the confocal optics further include a lens disk.

38.-43. (canceled)

44. A method of performing confocal microscopy, comprising:
providing the system claim 1;
providing a sample; and
using the system to form an image of the sample.

45. (canceled)

46. The method of claim 44, the free-space optics linkage having a beam expander comprising an upstream lens and a pair of candidate downstream collimating lenses, wherein the upstream lens has a smaller diameter and a shorter focal length than a diameter and a focal length of either of the candidate downstream collimating lens, and wherein the focal lengths of the two candidate downstream collimating lenses are unequal, further comprising selecting the one of the two candidate downstream collimating lenses that most nearly fills without overfilling an imaging area of the detector to use in the beam expander.

47. The method of claim 46, further comprising:
replacing the detector with a new detector, and
replacing the downstream collimating lens with a new downstream collimating lens having a different focal length to better fill without overfilling an imaging area of the new detector.
